(19) United States
(12) Patent Application Publication
(10) Pub. No.: US 2006/0232510 A1
(43) Pub. Date: Oct. 19, 2006

(54) Plasma display device

(75) Inventors: Yoshikazu Kanazawa, Kawasaki (JP); Atsushi Yokoyama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Kawasaki (JP)

(21) Appl. No.: 11/387,048

(22) Filed: Mar. 23, 2006

(30) Foreign Application Priority Data
Mar. 24, 2005 (JP) 2005-085537

(51) Int. Cl. G09G 3/28

(52) U.S. Cl. 345/60

(57) ABSTRACT

A plasma display device is configured as having a first display line containing a first scanning electrode in a display region; a first non-display line including a second scanning electrode outside the display region; a first potential line capable of applying a first potential of a scanning pulse, the scanning pulse being composed of the first potential and a second potential; a second potential line capable of applying the second potential of the scanning pulse; a first switch connected between the first potential line and the first scanning electrode; a second switch connected between the second potential line and the first scanning electrode; and a first rectifying element connected between the first and second scanning electrodes, so as to make the plasma display device possible to generate voltage for the scanning electrode, without supplying any scanning pulse to the scanning electrodes outside the display region.

### CROSS-REFERENCE TO RELATED APPLICATIONS

This application is based upon and claims the benefit of priority from the prior Japanese Patent Application No. 2005-085537, filed on Mar. 24, 2005, the entire contents of which are incorporated herein by reference.

### BACKGROUND OF THE INVENTION

1. Field of the Invention

The present invention relates to a plasma display device.

2. Description of the Related Art

A plasma display panel has a display region composed of a plurality of display lines. Depending on the configuration of plasma display device, it is necessary to provide a non-display region having the same structure with the display region on the upper and lower sides thereof, in order to equalize the structure of the uppermost display line and the lowermost display line in the display region with the structure of the center portion. The non-display region is not contributive to display.

Japanese Patent Application Laid-Open No. 2003-308782 describes a plasma display panel capable of sustaining a stable discharge in the display region, while reducing fault discharge possibly occurs in the non-display region in the neighborhood of the display region.

It is necessary for the scanning electrodes in the display region to be supplied with scanning pulses, but it is not necessary for the scanning electrodes in the non-display region to be supplied with the scanning pulses (non-display lines are not designed for input of the scanning pulses). The scanning electrode in the non-display region can be supplied with voltage when there is an excessive number of output of the scanning driver. Whereas for the case without excessive number of output of the scanning driver, the number of output of the scanning driver must be increased for the scanning electrodes in the non-display region.

### SUMMARY OF THE INVENTION

It is therefore an object of the present invention to provide a plasma display device capable of generating voltage for the scanning electrodes so as to supply scanning pulses to the scanning electrodes in the display region, and so as to not supply scanning pulses to the scanning electrodes outside the display region.

According to one aspect of the present invention, there is provided a plasma display device which has a first display line including a first scanning electrode in a display region; a first non-display line including a second scanning electrode outside the display region; a first potential line capable of applying a first potential of a scanning pulse, the scanning pulse being composed of the first potential and a second potential; a second potential line capable of applying the second potential of the scanning pulse; a first switch connected between the first potential line and the first scanning electrode; a second switch connected between the second potential line and the first scanning electrode; and a first rectifying element connected between the first and second scanning electrodes.

### BRIEF DESCRIPTION OF THE DRAWINGS

FIG. 1 is a drawing showing an exemplary configuration of a plasma display device;

FIGS. 2A to 2C are sectional views showing exemplary configurations of the cell;

FIG. 3 is a drawing showing an exemplary configuration of an image frame;

FIG. 4 is a drawing showing an exemplary configuration of a sub-frame;

FIG. 5 is a circuit diagram showing an exemplary configuration of a Y driving circuit and a scanning driver;

FIG. 6 is a circuit diagram showing a principle of another exemplary configuration of the scanning driver and a sustaining circuit;

FIG. 7 is a circuit diagram showing an exemplary configuration of the Y driving circuit and the scanning driver materializing the principle circuit shown in FIG. 6;

FIG. 8 is a drawing showing an exemplary configuration of a plasma display device having no aging Y electrode;

FIG. 9 is a circuit diagram showing an exemplary configuration of the Y driving circuit and the scanning driver according to the first embodiment of the present invention;

FIG. 10 is a drawing showing an exemplary configuration of the scanning driver;

FIG. 11 is a drawing showing an exemplary configuration of the sub-frame;

FIG. 12 is a drawing showing an exemplary configuration of the plasma display device according to the first embodiment of the present invention; and

FIG. 13 is a circuit diagram showing an exemplary configuration of the Y driving circuit and the scanning driver according to the second embodiment of the present invention.

### DETAILED DESCRIPTION OF THE PREFERRED EMBODIMENTS

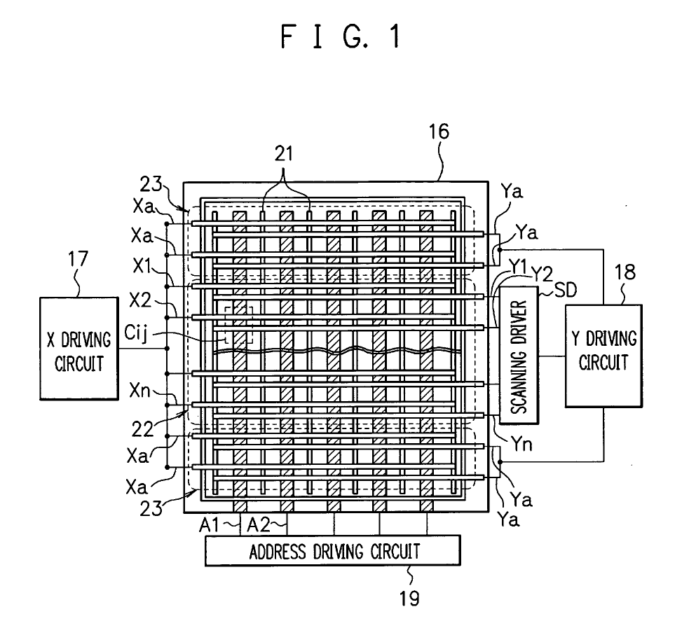

FIG. 1 is a drawing showing an exemplary configuration of a plasma display device. The plasma display panel 16 has a display region 22, and non-display regions 23 on the upper and lower sides thereof. The display region 22 has X electrodes X1 to Xn and scanning electrodes (referred to as Y electrodes, hereinafter) Y1 to Yn as the display lines. The non-display region 23 is a region outside the display region 22, and has X electrodes Xa and Y electrodes Ya as the non-display lines.

An X driving circuit 17 supplies a same predetermined voltage to a plurality of X electrodes X1 to Xn, Xa. In the description below, the X electrodes X1 to Xn, Xa will respectively or generally be referred to as “X electrode Xi”, where “i” means the suffix. A Y driving circuit 18 and a scanning driver SD supply a predetermined voltage to a plurality of Y electrodes Y1 to Yn, Ya. In the description below, the Y electrodes Y1 to Yn, Ya will respectively or generally be referred to as “Y electrode Yi”, where “i” means the suffix. The scanning driver SD is a circuit generating scanning pulses. An address driving circuit 19 supplies a predetermined voltage to a plurality of address electrodes A1, A2, . . . . In the description below, the address electrodes A1, A2, . . . will respectively or generally be referred to as “address electrode Aj”, where “j” means the suffix.

In the plasma display panel 16, the Y electrodes Yi and the X electrodes Xi form rows which extend horizontally and in parallel with each other, and the address electrodes Aj form columns which vertically extend. The Y electrodes Yi and the X electrodes Xi are alternately arranged in the vertical direction. The Y electrodes Yi and the address electrodes Aj form an i×j two-dimensional matrix. A cell Cij is formed by an intersection of each of the Y electrodes Yi and the address electrodes Aj, and adjacent one of X electrodes Xi corresponded thereto. The cell Cij corresponds to a pixel, so that the panel 16 can display a two-dimensional image composed of a plurality of lines. Ribs (barrier) 21 form a stripe pattern vertically extending in parallel with each other, so as to partition the individual cells.

The display region 22 is provided at the center of the plasma display panel 16, and is exposed to the external. In the display region 22, the cells Cij form the display cells, and the X electrodes Xi and the Y electrodes Yi form the display lines. The uppermost (top) display line of the display region 22 is composed of X electrode X1 and Y electrode Y1, and the lowermost (bottom) display line is composed of X electrode Xn and Y electrode Yn. The non-display regions 23 are provided on the upper and lower ends of the plasma display panel 16, and are not exposed to the external. In the non-display regions 23, the cells Cij form the non-display cells, and the aging X electrodes Xa and the aging Y electrodes Ya compose the non-display lines. The display region 22 and the non-display region 23 have an identical structure.

The non-display regions 23 have several sets of aging electrodes Xa, Ya, and are provided in order to ensure stable operation of the plasma display panel 16. Supposed that there were no non-display regions 23, the display lines in the center portion of the display region 22 would have the upper and lower lines adjacent thereto, but the uppermost line in the display region 22 would have no upper line adjacent thereto, and the lowermost display line in the display region 22 would have no lower line adjacent thereto. In such a case, the uppermost display line and the lowermost display line would differ from the display lines in the center portion with respect to states of load and electric charge, and would differ in operation characteristics. Provision of the non-display regions 23 on the upper and lower sides of the display region 22, therefore, makes it possible to equalize the states of load and electric charges of the uppermost display line and the lowermost display line in the display region 22 with those of the display lines in the center portion, and consequently to equalize the operation characteristics.

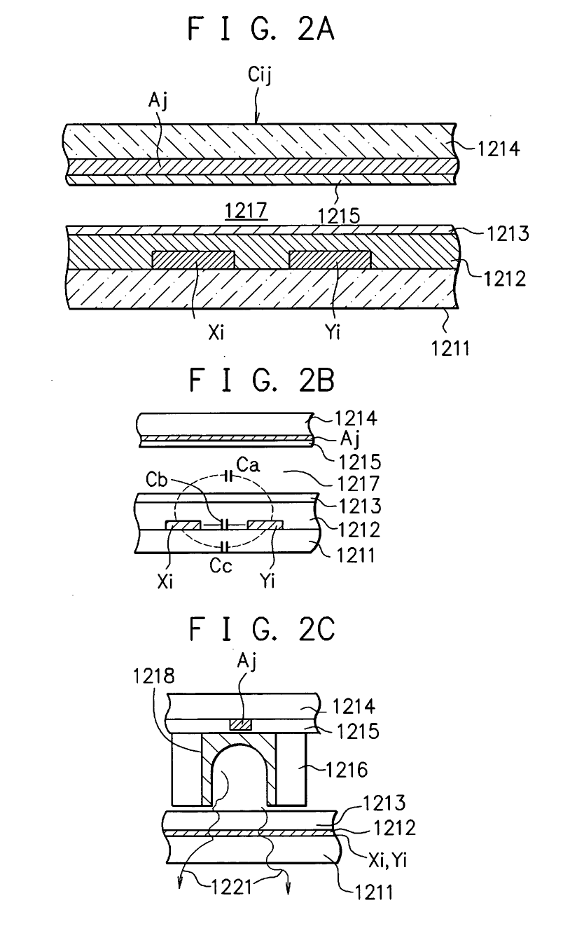

FIG. 2A is a sectional view showing an exemplary configuration of the cell Cij shown in FIG. 1. The X electrode Xi and the Y electrode Yi are formed on a front glass substrate 1211. Formed thereon is a dielectric layer 1212 ensuring electric isolation from a discharging space 1217, and further thereon, a MgO (magnesium oxide) protection film 1213 is formed.

On the other hand, the address electrode Aj is formed on a rear glass substrate 1214 disposed so as to oppose with the front glass substrate 1211, a dielectric layer 1215 is formed thereon, and fluorescent materials are placed further thereon. The discharging space 1217 between the MgO protection film 1213 and the dielectric layer 1215 is filled with Ne+Xe Penning gas and the like.

FIG. 2B is a drawing explaining capacitance Cp of an AC-driven plasma display. Capacitance Ca represents capacitance of the discharging space 1217 between the X electrode Xi and the Y electrode Yi. Capacitance Cb represents capacitance of the dielectric layer 1212 between the X electrode Xi and the Y electrode Yi. Capacitance Cc represents capacitance of the front glass substrate 1211 between the X electrode Xi and the Y electrode Yi. Panel capacitance Cp between the electrodes Xi and Yi is determined by a sum of these capacitances Ca, Cb and Cc.

FIG. 2C is a drawing explaining light emission of the AC-driven plasma display. On the inner surface of the rib (partition) 1216, there are coated red, blue and green fluorescent materials 1218 as being arranged by colors to form a stripe pattern, and thereby the display is configured to emit light 1221 based on excitation of the fluorescent materials by electric discharge between the X electrode Xi and the Y electrode Yi (discharging electrode pair) for pixel-wise display.

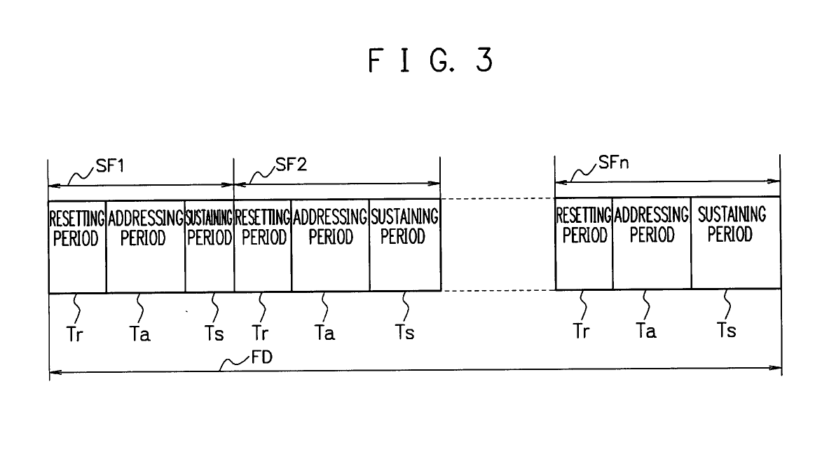

FIG. 3 is a drawing showing an exemplary configuration of an image frame FD. Two-dimensional image data is displayed by frames on the panel 16. Each frame FD is composed of the first sub-frame SF1, the second sub-frame SF2, . . . , and the n-th sub-frame SFn. The number “n” is 10, for example, and corresponds to the number of gradation bit. The sub-frames SF1, SF2 and so forth will respectively or generally be referred to as “sub-frame SF”, hereinafter.

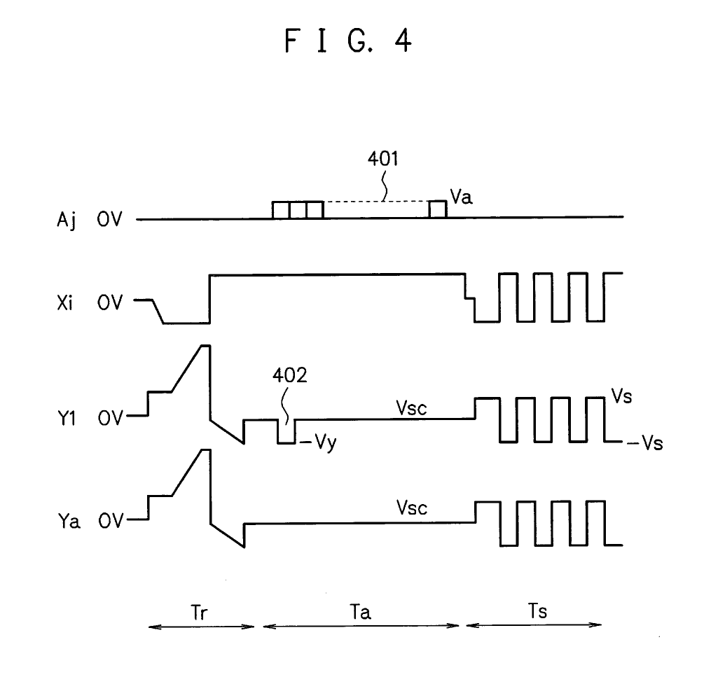

FIG. 4 is a drawing showing an exemplary configuration of the sub-frame SF. Each sub-frame Sf has a resetting period Tr, an addressing period Ta and a sustaining (discharge-sustaining) period Ts. In the resetting period Tr, the cell is initialized.

In the addressing period Ta, emission or non-emission of each cell is selectable by address discharge between the address electrode Aj and the Y electrode Yi. More specifically, emission or non-emission of a desired cell can be selected by applying scanning pulse 402 sequentially to the Y electrode Y1, 2, Y3, Y4, . . . , Yn, and applying address pulse 401 to the address electrode Aj corresponding to the scanning pulse 402. The scanning pulse 402 is composed of a potential Vsc and a negative potential −Vy lower than Vsc. The Y electrodes Y1 to Yn have the potential −Vy when the scanning pulse is applied, and have the potential Vsc when the scanning pulse is not applied. Voltage waveforms of the Y electrodes Y1 to Yn differ only in timing of the scanning pulse 402.

In the sustaining period Ts, the X electrodes Xi and the Y electrodes Yi are alternately supplied with sustaining pulses having phases inverted from each other. The sustaining pulse is composed of a positive potential +Vs and a negative potential −Vs. In the sustaining period Ts, sustaining discharge occurs between the X electrodes Xi and the Y electrodes Yi in the cells for which emission is selected, and thereby light emission occurs. The individual sub-frames SF have, as shown in FIG. 3, different number of times of light emission (length of the sustaining period Ts) due to sustaining pulses between the X electrodes Xi and the Y electrodes Yi. This make it possible to determine gradation values.

Because the X driving circuit 17 shown in FIG. 1 applies the same voltage to the X electrodes X1 to Xn, also the aging X electrodes Xa are applied with the same voltage. The scanning driver SD is a circuit supplying the scanning pulse 402 to the Y electrodes Y1 to Yn. The Y electrodes Y1 to Yn are affected by the number of display lines and the number of bit of the scanning driver SD, because they are respectively applied with the scanning pulses 402 at different timing. For example, the scanning driver SD is configured as an IC, and generally designed to provide a 64-bit output. As for a 480-line panel 16 known as a VGA-mode one, use of eight 64-bit scanning driver ICs provides 512 outputs, and affords 32 excessive outputs over 480 lines, which can be used as the scanning drivers for the upper and lower dummy electrodes Ya.

On the other hand, as for the panel known as a ALIS-mode one, 512 Y electrodes Y1 to Yn can display 1024 lines. In this case, all of 512 outputs of eight scanning driver ICs are used for 512 lines of the electrode Y1 to Yn, so that there is no excessive outputs of scanning driver IC available for the aging Y electrodes Ya. A circuit for the solution will be explained below.

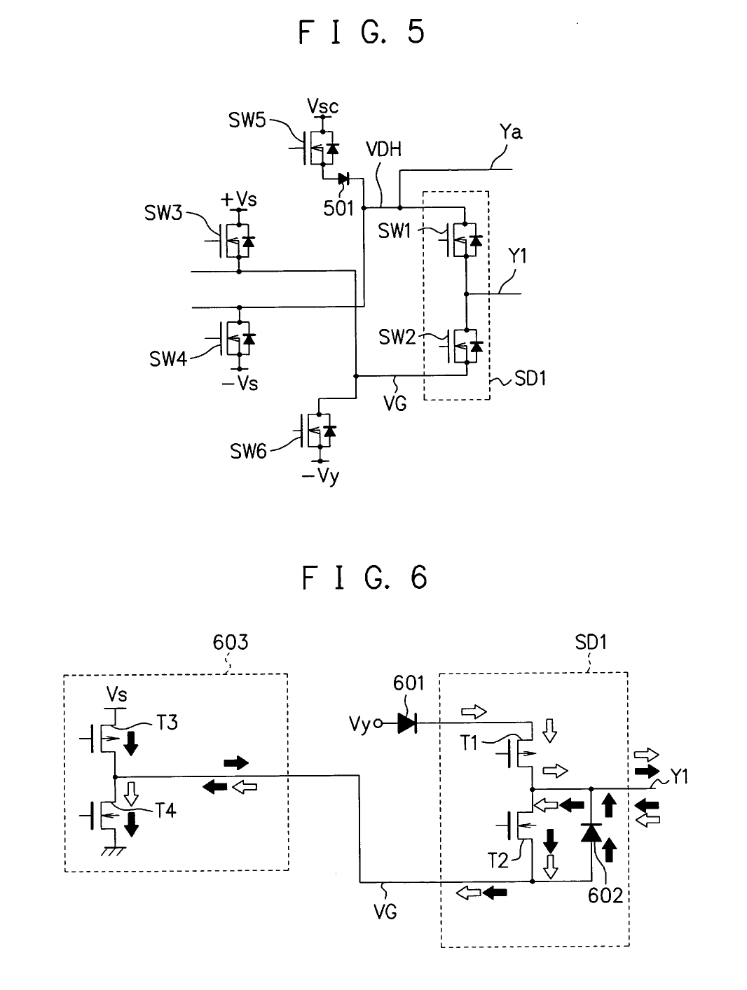

FIG. 5 is a circuit diagram showing an exemplary configuration of the Y driving circuit 18 and the scanning driver SD. MOS field effect transistors will simply be referred to as “transistors”, hereinafter. An n-channel transistor has a parasitic diode, the source of which is connected to the anode of the parasitic diode, and the drain of which is connected to the cathode of the parasitic diode.

To the Y electrode Y1, switches SW1 and SW2 are connected. The switches SW1 and SW2 compose a scanning driver SD1. The switch SW1 is composed of an n-channel transistor, and is connected between the Y electrode Y1 and the first potential line VDH. The switch SW2 is composed of an n-channel transistor, and is connected between the Y electrode Y1 and the second potential line VG. A switch SW3 is composed of an n-channel transistor, and is connected between the potential +Vs and the second potential line VG. A switch SW4 is connected between the potential −Vs and the first potential line VDH. A switch SW5 is connected between the potential Vsc and the anode of a diode 501. The cathode of the diode 501 is connected to the first potential line VDH. The aging Y electrode Ya is connected to the first potential line VDH. The first potential line VDH is connected to the power source terminal of the scanning driver SD1, and the second potential line VG is connected to the reference terminal of the scanning driver SD1.

In FIG. 5, circuits other than the scanning driver SD1 correspond to the Y driving circuit 18 shown in FIG. 1. The scanning driver SD1 is provided for the Y electrode Y1. The scanning driver SD has scanning drivers SD2 to SDn, besides the scanning driver SD1. The scanning drivers SD2 to SDn are configured identically to the scanning driver SD1, connected to the scanning driver SD1 in parallel therewith, and respectively connected to the Y electrodes Y2 to Yn. The Y driving circuit 18 is provided as a single component commonly for the Y electrodes Y1 to Yn, Ya. To the Y electrodes Y1 to Yn, the scanning pulse is supplied from the scanning driver SD. The aging Y electrode Ya can be supplied with the potential Vsc through the switch SW5, but is not supplied with the potential −Vy of the scanning pulse. Voltage waveform of the aging Y electrode Ya is therefore, as shown in FIG. 4, such as those of the Y electrode Y1 to Yn from which the scanning pulse 402 is omitted. The scanning pulse is not necessary for the aging Y electrode Ya, because it is an electrode in the non-display region 23.

FIG. 6 is a circuit diagram showing a principle of another exemplary configuration of the scanning driver SD1 and a sustaining circuit 603. Circuits other than the scanning driver SD1 correspond to the Y driving circuit 18 shown in FIG. 1. The scanning driver SD1 is a circuit generating the scanning pulse, and has switches T1, T2 and a diode 602. The scanning pulse is composed of a potential Vy and the ground potential, for example. The sustaining circuit 603 is a circuit generating the sustaining pulse in the sustaining period Tr shown in FIG. 4, and has switches T3 and T4. The sustaining pulse is composed of the potential Vs and the ground potential, for example.

The switch T1 is composed of a p-channel transistor, and is connected between the cathode of the diode 601 and the Y electrode Y1. The anode of the diode 601 is connected to the potential Vy. The switch T2 is composed of an n-channel transistor, and is connected between the potential line VG and the Y electrode Y1. The diode 602 has the anode connected to the potential line VG, and has the cathode connected to the Y electrode Y1. The switch T3 is composed of a p-channel transistor, and is connected between the potential Vs and the potential line VG. The switch T4 is composed of an n-channel transistor, and is connected between the potential line VG and the ground potential.

The scanning pulse is composed of the potential Vy and the ground potential. The potential Vy of the scanning pulse is supplied to the Y electrode Y1 through the diode 601 and the switch T1. When the potential of the Y electrode Y1 is lowered from Vy to the ground potential, positive charge in the Y electrode Y1 flows through the switches T2 and T4 to the ground potential.

The sustaining pulse is composed of the potential Vs and the ground potential. The potential Vs of the sustaining pulse is supplied through the switch T3 and the diode 602 to the Y electrode Y1. When the potential of the Y electrode Y1 is lowered from Vs to the ground potential, positive charge in the Y electrode Y1 flows through the switches T2 and T4 to the ground potential.

In the circuit shown in FIG. 5, the first potential line VDH is a line supplying the potential −Vs of the sustaining pulse, and the second potential line VG is a line supplying the potential +Vs of the sustaining pulse, so that the configuration is made complicated due to two large-power lines. In contrast to this, in the circuit shown in FIG. 6, the potential line VG is provided as a common line supplying the potentials +Vs and −Vs of the sustaining pulse, simplifying the configuration by virtue of presence of only a single large-power line.

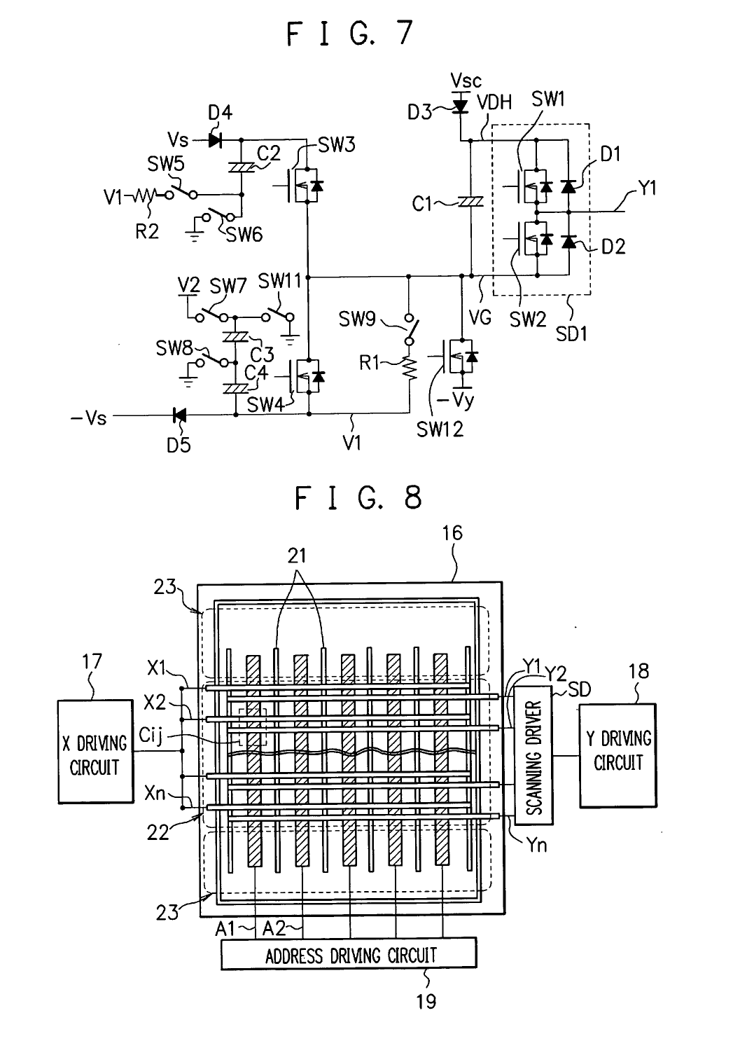

FIG. 7 is a circuit diagram showing an exemplary configuration of the Y driving circuit 18 and the scanning driver SD materializing the principle circuit shown in FIG. 6. The electrode Y1 can be applied with voltage shown in FIG. 4. The n-channel transistor has a parasitic diode, the source of which is connected to the anode of the parasitic diode, and the drain of which is connected to the cathode of the parasitic diode.

The scanning driver SD1 has switches SW1, SW2 and diodes D1, D2, and is connected to the Y electrode Y1. The switch SW1 is composed of an n-channel transistor, and is connected between the Y electrode Y1 and the first potential line VDH. The switch SW2 is composed of an n-channel transistor, and is connected between the Y electrode Y1 and the second potential line VG. The diode D1 has the anode connected to the Y electrode Y1, and has the cathode connected to the first potential line VDH. The diode D2 has the anode connected to the second potential line VG, and has the cathode connected to the Y electrode Y1. The first potential line VDH is connected to the power source terminal of the scanning driver SD1, and the second potential line VG is connected to the reference terminal of the scanning driver SD1.

The diode D3 has the anode connected to the potential Vsc, and has the cathode connected to the first potential line VDH. The capacitor C1 is connected between the potential lines VDH and VG. The switch SW12 is composed of an n-channel transistor, and is connected between the second potential line VG and the potential −Vy. A series connection of the switch SW9 and a resistor R1 is connected between the second potential line VG and the potential line V1.

The switch SW4 is composed of an n-channel transistor, and is connected between the second potential line VG and the potential line V1. A switch SW7 is connected between the potential V2 and the upper end of a capacitor C3. A switch SW11 is connected between the ground potential and the upper end of the capacitor C3. A switch SW8 is connected between the ground potential and the lower end of the capacitor C3. A capacitor C4 is connected between the lower end of the capacitor C3 and the potential line V1. A diode D5 has the anode connected to the potential line V1, and has the cathode connected to the potential −Vs.

The switch SW3 is composed of an n-channel transistor, and is connected between the cathode of the diode D4 and the second potential line VG. The anode of the diode D4 is connected to the potential Vs. The upper end of the capacitor C2 is connected to the cathode of the diode D4. A series connection of a resistor R2 and a switch SW5 is connected between the potential V1 and the lower end of a capacitor C2. A switch SW6 is connected between the ground potential and the lower end of the capacitor C2.

In FIG. 7, circuits other than the scanning driver SD1 correspond to the Y driving circuit 18 shown in FIG. 1. The scanning driver SD1 is provided for the Y electrode Y1. The scanning driver SD has scanning drivers SD2 to SDn, besides the scanning driver SD1. The scanning drivers SD2 to SDn are configured identically to the scanning driver SD1, connected to the scanning driver SD1 in parallel therewith, and respectively connected to the Y electrodes Y2 to Yn. The Y driving circuit 18 is provided as a single component commonly for the Y electrodes Y1 to Yn. To the Y electrodes Y1 to Yn, scanning pulse is supplied from the scanning driver SD.

The Y electrode Y1 is applied with voltage waveform shown in FIG. 4. In the resetting period Tr, a positive resetting voltage is generated using the potential V1 and the potential Vs, and a negative resetting voltage is generated using the potential V2 and the potential −Vs. In the addressing period Ta, the voltage is generated using the potential Vsc and potential −Vy. In the sustaining period Ts, the sustaining pulse is generated using the potential Vs and the potential −Vs.

In this case, similarly to as in the circuit shown in FIG. 5, the voltage of the aging Y electrode Ya as shown in FIG. 4 cannot be obtained even if the aging Y electrode Ya is connected to the first potential line VDH. The circuit shown in FIG. 7 is, however, applicable to the plasma display device having no aging Y electrode Ya as shown in FIG. 8.

FIG. 8 shows an exemplary configuration of the plasma display device having no aging Y electrode Ya, which differs from the configuration shown in FIG. 1 in having no aging electrodes Xa, Ya. In the plasma display panel 16 in which the ribs 21 partitioning the cells form a stripe pattern, it is necessary, as described in the above, to arrange the electrodes also in the non-display region 23 so as to configure the cells similarly to as in the display region 22. Also in the cells in the non-display region 23, it is necessary to apply voltage for the aging electrodes Xa, Ya as shown in FIG. 4, so as to stabilize the discharge at the uppermost display line and the lowermost display line in the display region 22.

For the case where the aging Y electrode Ya is driven by the circuit shown in FIG. 7, use of eight 64-bit-output scanning driver ICs results in 512 outputs. For an exemplary case of using 512 Y electrodes Y1 to Yn in the display region 22, all of such 512 outputs of the scanning driver ICs are used for the Y electrodes Y1 to Yn. Because there is no excessive output of the scanning driver ICs driving the aging Y electrodes Ya, it is therefore necessary to add another scanning driver IC, or to newly develop a 65-bit scanning driver IC. The paragraphs below will explain a circuit capable of driving the aging Y electrodes Ya using currently-available scanning driver ICs without increasing the number of IC.

### First Embodiment

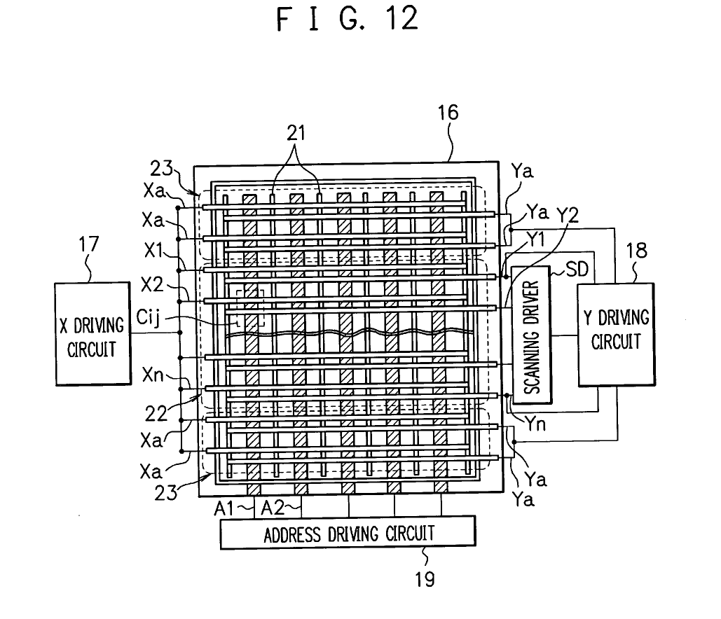

FIG. 12 is a drawing showing an exemplary configuration of a plasma display device according to the first embodiment of the present invention, which is different from FIG. 1 in that the Y electrode Y1 of the uppermost display line and the Y electrode Yn of the lowermost display line in the display region 22 are connected also to the Y electrode driving circuit 18. Other configurations are same as those shown in FIG. 1. The same explanations for FIGS. 2A to 2C and FIG. 3 will apply hereinafter.

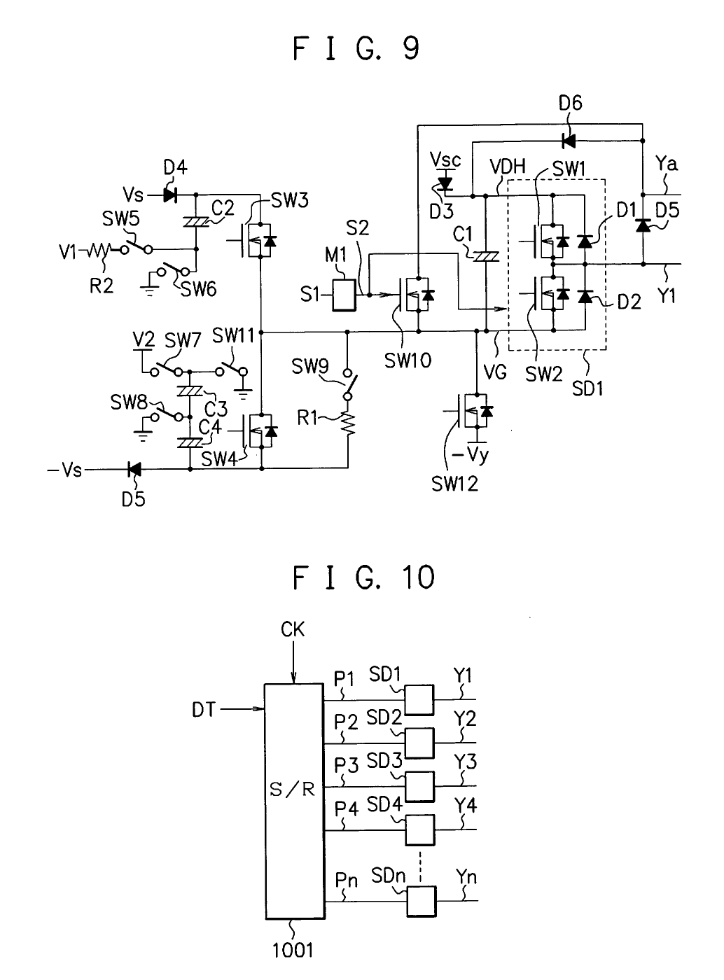

FIG. 9 is a circuit diagram showing an exemplary configuration of the Y driving circuit 18 and the scanning driver SD shown in FIG. 12. Only aspects differing from those in FIG. 7 will be explained below. Other aspects are same with those shown in FIG. 7. The diode D5 has the anode connected to the Y electrode Y1, and the cathode connected to the aging Y electrode Ya. A diode D6 has the anode connected to the aging Y electrode Ya, and the cathode connected to the first potential line VDH. A switch SW10 is composed of an n-channel transistor, and is connected between the aging Y electrode Ya and the second potential line VG.

A signal generation circuit M1 receives an input of control signal S1, and converts the reference potential thereof to generate and outputs a control signal S2. The control signal S1 is a 5-V signal with reference to the ground potential. The control signal S2 is a 5-V signal with reference to the potential of the second potential line VG. The switch SW10 receives through the control terminal (gate terminal) thereof, the control signal S2. The same control signal S2 is input also to the scanning driver SD1.

In FIG. 9, circuits other than the scanning driver SD1 correspond to the Y driving circuit 18 shown in FIG. 12. The scanning driver SD1 is provided for the Y electrode Y1. The scanning driver SD has the scanning drivers SD2 to SDn, besides the scanning driver SD1. The scanning drivers SD2 to SDn have the same configuration with the scanning driver SD1, connected in parallel with the scanning driver SD1, and respectively connected to the Y electrodes Y2 to Yn. The control signal S2 is input also to the scanning drivers SD2 to SDn. The Y driving circuit 18 is provided as a single component commonly for the Y electrodes Y1 to Yn. To the Y electrodes Y1 to Yn, the scanning pulse is supplied from the scanning driver SD. The scanning pulse is not supplied to the aging Y electrodes Ya.

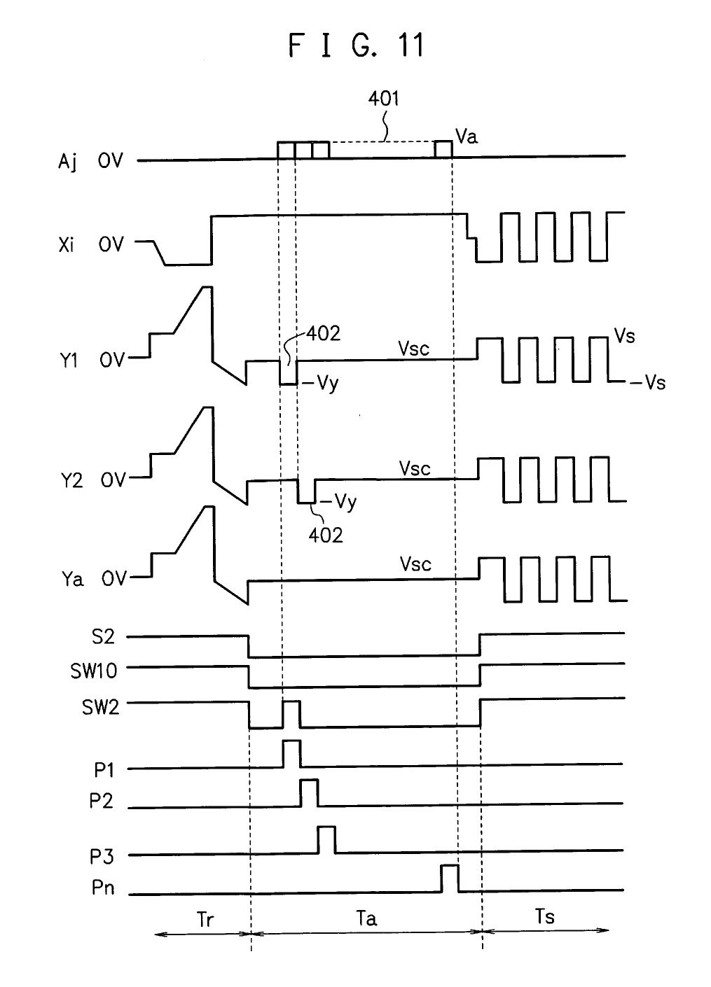

FIG. 11 is a drawing showing an exemplary configuration of the sub-frame SF shown in FIG. 3. Voltages for the address electrode Aj, the X electrode Xi, the Y electrodes Y1 to Yn, and Y electrode Ya are same as those explained referring to FIG. 4. The control signal S2 has the high level in the resetting period Tr and the sustaining period Ts, and has the low level in the addressing period Ta. The switch SW10 is controlled by the control signal S2, turned on in the resetting period Tr and the sustaining period Ts, and turned off in the addressing period Ta.

FIG. 10 is a drawing showing an exemplary configuration of the scanning driver SD shown in FIG. 12. The scanning driver SD has a shift register 1001 and the scanning drivers SD1 to SDn. Upon input of data DT, the shift register 1001 outputs timing pulse signals P1 to Pn, shown in FIG. 11, sequentially to the scanning drivers SD1 to SDn, in synchronization with a clock CK. The timing pulse signals P1 to Pn are signals indicating timing of applying the scanning pulse 402 respectively to the Y electrodes Y1 to Yn. The scanning drivers SD1 to SDn are respectively connected to the Y electrodes Y1 to Yn.

The scanning driver SD1 controls the switches SW1 and SW2 based on the control signal S2 and the timing pulse signal P1. The switch SW2 turns on in the resetting period Tr and the sustaining period Ts, turns on in the addressing period Ta only when the timing pulse signal P1 is in the high level, and turns off when in the low level.

In the addressing period Ta, the Y electrode Y1 can be supplied with the potential Vsc by turning the switch SW1 on and turning the switch SW2 off. The potential Vsc is supplied through the diode D3 and the switch SW1 to the Y electrode Y1, and thereby the potential Vsc is applied to the Y electrode Y1. The potential Vsc of the Y electrode Y1 is supplied through the diode D5 to the aging Y electrodes Ya, and thereby the potential Vsc is applied to the aging Y electrodes Ya.

In the addressing period Ta, the Y electrode Y1 can be supplied with the potential −Vy by turning the switch SW1 off, and turning the switch SW2 and the switch SW12 on. The potential −Vy is supplied through the switches SW2 and SW12 to the electrode Y1, and thereby the potential −Vy is applied to the Y electrode Y1. The diode D5 being applied with reverse voltage does not activate, and thereby the potential Vsc of the aging Y electrode Ya is sustained.

The scanning drivers SD2 to SDn respectively control the switches SW1 and SW2 of their own, similarly to the scanning driver SD1, based on the control signal S2 and the timing pulse signals P2 to Pn. The potential of the Y electrodes Y2 to Yn differs from that of the Y electrode Y1 only in the timing of the scanning pulse 402. The potential of the aging Y electrodes Ya differs from that of the Y electrodes Y1 to Yn only in that it has no scanning pulse 402.

In the resetting period Tr and the sustaining period Ts, the switches SW2 and SW10 show the same on/off operation. The potential of the second potential line VG is supplied through the switch SW2 to the Y electrode Y1, and through the switch SW10 to the aging Y electrode Ya. In the resetting period Tr and the sustaining period Ts, the Y electrode Y1 and the aging Y electrode Ya therefore have the same potential.

The description in the above have dealt with the case where the anode of the diode D5 is connected to the Y electrode Y1, whereas the anode of the diode D5 may be connected to any of the Y electrodes Y1 to Yn. It is to be noted, however, that the diode D5 is preferably connected between the Y electrode Y1, which is the uppermost display line in the display region 22, and the aging Y electrode Ya adjacent thereto on the upper side thereof, which is a non-display line, as shown in FIG. 12 in view of simplifying the interconnection. Similarly, another diode corresponded to the diode D5 is preferably connected between the Y electrode Yn, which is the lowermost display line in the display region 22, and the aging electrode Ya adjacent thereto on the lower side thereof, which is a non-display line.

As described in the above, the anode of the diode D5 is connected to the output electrode Y1 of the scanning driver SD1, and the cathode of the diode D5 is connected to the aging Y electrode Ya. The diode D6 is additionally connected between the aging Y electrode Ya and the first potential line VDH. The switch SW10 is connected between the aging Y electrode Ya and the second potential line VG. The switch SW2 operates based on the control signal S2 of the switch SW10.

As shown in FIG. 11, the switches SW2 and SW10 turn on outside the addressing period Ta. For example, in the resetting period Tr and the sustaining period Ts, voltage of the Y electrodes Y1 to Yn, Ya can be raised by applying voltage from the second potential line VG through the diode D2 to the Y electrodes Y1 to Yn, and the same level of voltage is applied through the diode D5 to the aging Y electrodes Ya. When the voltage of the Y electrodes Y1 to Yn, Ya is lowered, the electrodes Y1 to Yn withdraw current through the switch SW2 from the second potential line VG side. The aging Y electrodes Ya withdraw current through the diode D6 and the switch SW10.

On the other hand, in the addressing period Ta, the switch SW1 turns on so as to supply non-selective potential Vsc to the Y electrodes Y1 to Yn. Also the aging Y electrodes Ya are applied with the same voltage through the diode D5. When the address pulse 401 of the address electrode Aj rises up and the Y electrode Y1 is applied with the potential −Vy, current flows through the diode D6 to the capacitor C1, and this consequently makes it possible to sustain the potential of the aging Y electrodes Ya at Vsc. Although the switch SW10 was additionally provided, the control signal S2 operating the switch SW10 is same as that used for turning the switch SW2 on outside the addressing period Ta, so that there is no need of providing an additional control signal. The control signal S2 of the scanning driver SD generally operates at 5 V, whereas use of a 5-V transistor also for the switch SW10 makes it no more necessary to use any specialized gate driver IC or gate driving power source. There is also a general need of isolating the control signals S1 and S2 in the signal generation circuit M1, because the second potential line VG, which is the reference terminal of the scanning driver SD, is overlaid with output voltages from circuits on the switch SW3 and SW4 sides, and is isolated from the ground potential, and this forms a basis of using a photo-coupler, but use of the signal S2 in common makes it no more necessary to add a new circuit.

### Second Embodiment

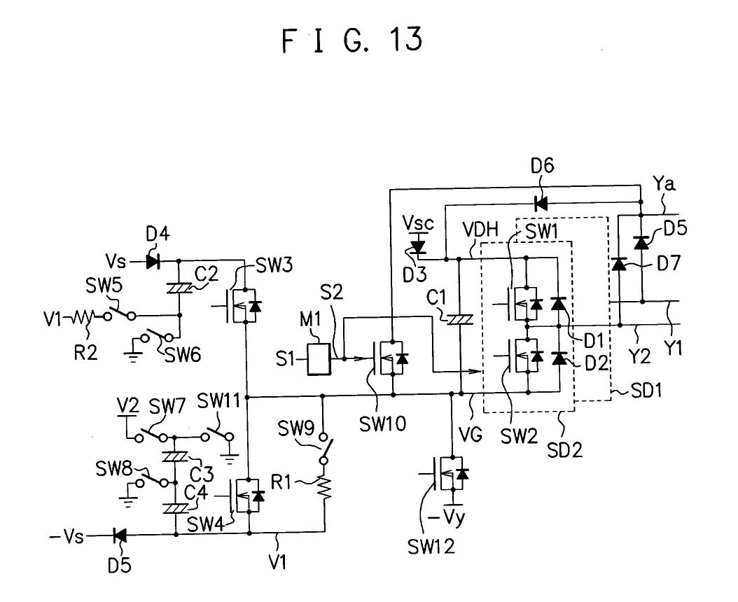

FIG. 13 is a circuit diagram showing an exemplary configuration of the Y driving circuit 18 and the scanning driver SD according to the second embodiment of the present invention. Only aspects differing from those in FIG. 9 will be explained below. Other aspects are same with those shown in FIG. 9. The scanning driver SD2 has the same configuration with the scanning driver SD1 shown in FIG. 9, and is connected in parallel with the scanning driver SD1, in which the interconnection node of the switches SW1 and SW2 is connected to the Y electrode Y2. In addition, a diode D7 has the anode connected to the Y electrode Y2, and the cathode connected to the aging Y electrode Ya.

In the circuit of the first embodiment previously shown in FIG. 9, the Y electrode Y1 was applied with the scanning pulse by turning the switch SW2 on. In this case, the potential of the aging Y electrode Ya was slightly lowered due to parasitic capacitance of the diode D5. Because degree of lowering in the voltage is determined by a ratio of capacitance between the aging Y electrodes Ya through the panel 16 portion to the parasitic capacitance of the diode D5, lowering in the potential hardly occurs. Due to such small through-the-panel capacitance of the aging Y electrodes Ya, it is however necessary to realize a circuit not causative of voltage drop, for the case where a large voltage drop is anticipated, or for the case where only a slight voltage drop adversely affects discharge control or the like. Such voltage drop never occurs in the circuit shown in FIG. 13, because addition of the diode D7 makes it possible to synthesize voltages on two Y electrodes Y1 and Y2 to thereby generate voltage for the aging Y electrodes Ya.

It is to be noted herein that the aging Y electrode Ya is not limited as being connected with the Y electrodes Y1 and Y2 through the diodes D5 and D7. It is all enough that the aging Y electrode Ya is connected with any two or more of the Y electrodes Y1 to Yn through the diodes.

As has been described in the above, the first and the second embodiments make it possible to generate an optimum voltage for the aging Y electrodes Ya, by synthesizing the potential of the output electrode Y1 of the scanning driver SD1 driving the electrode Y1 in the display region 22 with the potential of the first potential line VHD or of the second potential line VG by combining the diodes, switches and so forth.

The first display line includes the Y electrode Y1 in the display region 22. The first non-display line includes the Y electrode Ya outside the display region 22. The scanning pulse is composed of the first potential Vsc and the second potential −Vy. The first potential line VDH can apply the first potential Vsc of the scanning pulse. The second potential line VG can apply the second potential −Vy of the scanning pulse. The switch SW1 is connected between the first potential line VDH and the Y electrode Y1. The switch SW2 is connected between the second potential line VG and the Y electrode Y1. The diode D5 is connected between the Y electrodes Y1 and Ya. The diode D6 is connected between the Y electrode Ya and the first potential line VDH. The switch SW10 is connected between the Y electrode Ya and the second potential line VG. The diodes in the first and the second embodiments may be rectifying elements.

The aging Y electrode Ya is not supplied with the scanning pulse, and this makes it possible to reduce the number of output of the scanning driver SD. It is therefore no more necessary to increase the number of scanning driver IC or to develop a new scanning driver having a larger number of bit in order to increase the number of output of the scanning driver, and this contributes the cost reduction.

In the circuit shown in FIG. 5, there are two large current lines, which are the large-current line VDH supplying the potential −Vs of the sustaining pulse and the large-current-line VG supplying the potential +Vs of the sustaining pulse, and this complicates the configuration. In contrast to this, the circuits of the first and the second embodiments is simplified in the configuration, because the potential line VG is provided as a common line supplying the potentials +Vs and −Vs of the sustaining pulse, that is, because there is only one large-current line provided therein.

It is made possible to supply the scanning pulse to the first scanning electrode, and to supply no scanning pulse to the second scanning electrode. Because the second scanning electrode is not supplied with the scanning pulse, it is made possible to reduce the number of output of the scanning driver outputting the scanning pulses.

It is to be noted herein that the above-described embodiments are provided merely for the purpose of showing materialization of the present invention, by which the technical scope of the present invention should not limitedly be understood. In other words, the present invention may be embodied in various modified forms without departing from the technical spirit or principal features thereof.

What is claimed is:

1. A plasma display device comprising:
a first display line including a first scanning electrode in a display region;
a first non-display line including a second scanning electrode outside said display region;
a first potential line capable of applying a first potential of a scanning pulse, said scanning pulse being composed of said first potential and a second potential;
a second potential line capable of applying said second potential of said scanning pulse;
a first switch connected between said first potential line and said first scanning electrode;
a second switch connected between said second potential line and said first scanning electrode; and
a first rectifying element connected between said first and second scanning electrodes.

2. The plasma display device according to claim 1, further comprising a second rectifying element connected between said second scanning electrode and said first potential line.

3. The plasma display device according to claim 1, further comprising a third switch connected between said second scanning electrode and said second potential line.

4. The plasma display device according to claim 1, further comprising:
a second rectifying element connected between said second scanning electrode and said first potential line; and
a third switch connected between said second scanning electrode and said second potential line.

5. The plasma display device according to claim 4, further comprising:
a signal generation circuit generating a control signal used for turning said third switch on or off during an addressing period in which said scanning pulse is supplied to said first scanning electrode; and
a shift register generating a timing pulse teaching a timing according to which said scanning pulse should be applied to said first scanning electrode,
wherein said first and second switches are controlled based on said control signal and said timing pulse.

6. The plasma display device according to claim 4, wherein said display region is composed of a plurality of display lines,
said first display line is the uppermost display line in said display region, and
said first non-display line is a line adjacent to said first display line on the upper side thereof.

7. The plasma display device according to claim 6, further comprising:
a second display line including a third scanning electrode in said display region;
a second non-display line including a fourth scanning electrode outside said display region;
a fourth switch connected between said first potential line and said third scanning electrode;
a fifth switch connected between said second potential line and said third scanning electrode; and
a third rectifying element connected between said third and fourth scanning electrodes,
said second display line is the lowermost display line in said display region, and
said second non-display line is a line adjacent to said second display line on the lower side thereof.

8. The plasma display device according to claim 7, further comprising:
a fourth rectifying element connected between said first potential line and said first potential; and
a sixth switch connected between said second potential line and said second potential.

9. The plasma display device according to claim 8, further comprising:
a seventh switch connected between a third potential of a sustaining pulse, composed of said third and a fourth potentials, and said second potential line;
and an eighth switch connected between said fourth potential of said sustaining pulse and said second potential line.

10. The plasma display device according to claim 1, further comprising:
a second display line including a third scanning electrode in said display region;
a third switch connected between said first potential line and said third scanning electrode;
a fourth switch connected between said second potential line and said third scanning electrode; and
a second rectifying element connected between said second and third scanning electrodes.

11. The plasma display device according to claim 10, further comprising a third rectifying element connected between said second scanning electrode and said first potential line.

12. The plasma display device according to claim 10, further comprising a fifth switch connected between said second scanning electrode and said second potential line.

13. The plasma display device according to claim 10, further comprising:
a third rectifying element connected between said second scanning electrode and said first potential line; and,
a fifth switch connected between said second scanning electrode and said second potential line.

14. The plasma display device according to claim 13, further comprising:
a signal generation circuit generating a control signal used for turning said fifth switch off during an addressing period in which said scanning pulse is supplied to said first and third scanning electrodes; and
a shift register generating a timing pulse teaching a timing according to which said scanning pulse should be applied to said first and third scanning electrodes,
wherein said first to fourth switches are controlled based on said control signal and said timing pulse.

15. The plasma display device according to claim 13, wherein said display region is configured by a plurality of display lines;
said first display line is the uppermost display line in said display region; and
said first non-display line is a line adjacent to said first display line on the upper side thereof.

16. The plasma display device according to claim 15, further comprising:
a third display line including a fourth scanning electrode in said display region;
a second non-display line including a fifth scanning electrode outside said display region;
a sixth switch connected between said first potential line and said fourth scanning electrode;
a seventh switch connected between said second potential line and said fourth scanning electrode; and
a fourth rectifying element connected between said fourth and fifth scanning electrodes,
said third display line is a lowermost display line in said display region, and
said second non-display line is a line adjacent to said third display line on the lower side thereof.

17. The plasma display device according to claim 16, further comprising:
a fifth rectifying element connected between said first potential line and said first potential; and
an eighth switch connected between said second potential line and said second potential.

18. The plasma display device according to claim 17, further comprising:
a ninth switch connected between a third potential of a sustaining pulse, composed of said third and a fourth potentials, and said and second potential line; and
a tenth switch connected between the fourth potential of said sustaining pulse and said second potential line.
